(19) United States
(12) Patent Application Publication
(10) Pub. No.: US 2025/0065391 A1
(43) Pub. Date: Feb. 27, 2025

(54) MANUAL HYDRAULIC PIPE EXPANDER

(71) Applicant: ZHEJIANG VALUE MECHANICAL & ELECTRICAL PRODUCTS CO., LTD., Taizhou (CN)

(72) Inventor: Yourong JIANG, Taizhou (CN)

(21) Appl. No.: 18/700,173

(22) PCT Filed: Sep. 20, 2023
(86) PCT No.: PCT/CN2023/119970

§ 371 Date: Apr. 10, 2024

(30) Foreign Application Priority Data
Aug. 23, 2023 (CN) 2023222792765

(51) Int. Cl. B21D 41/02; B29C 57/04

(52) U.S. Cl. CPC B21D 41/021; B29C 57/04

(57) ABSTRACT

A manual hydraulic pipe expander operable by a single hand includes a handle with a gripping part operable by a single hand; a wrench provided rotatably relative to the handle; a plunger movable back and forth relative to the handle; a pipe expanding assembly including a pipe expanding tube, and a piston and a cone head provided in the pipe expanding tube; and an oil bag. The handle and the wrench are configured such that the projections of the wrench and the gripping part of the handle on a swinging plane formed by the wrench coincide with each other in a case that the swinging angle of the wrench is maximum. The manual hydraulic pipe expander operable by a single hand has the beneficial effect that it is more labor-saving.

### TECHNICAL FIELD

The present utility model belongs to the technical field of manual hydraulic pipe expanders, and specifically relates to a manual hydraulic pipe expander.

### BACKGROUND

US invention patent U.S. Pat. No. 9,987,672B2 discloses a manual hydraulic pipe expander, which mainly includes a handle, a wrench swingably provided on the handle, a plunger located below an upper end of the wrench, an oil bag provided in the handle, a one-way valve provided at an oil outlet position of the oil bag, an oil supply path, an oil return path, a piston, a cone head, and a pipe expanding head. The pipe expanding head is detachable to adapt to different pipe diameters. The working principle is to grip the handle in the palm of the hand, operate the wrench with fingers, and push the plunger during the movement of the wrench towards the handle to push the oil in the oil bag to the piston, causing the piston and the cone head to move outwards, so that the cone head radially expands the six sector-shaped components of the pipe expanding head outwards to achieve pipe expansion.

When using products similar to the US invention patent solution, the applicant found the following problems in the structure: 1) since the handle has a complete periphery, in a case that the wrench is abutted with the outer surface of the handle, the stroke of the plunger reaches its maximum; when operating with one hand, due to the size limit of the human hand, the maximum swinging angle of the wrench and the distance from the force point of the wrench (finger pressing position) to the rotation axis cannot be balanced; 2) the oil bag is provided in the handle, making the size of the handle larger and limiting the design space of the handle; 3) since the wrench is located below the cone head, the length of the wrench is limited; 4) the movement direction of the plunger is opposite to the movement direction of the piston, the oil path is complex and the manufacturing difficulty is great; at the same time, the oil path is long and has turns, which is not conducive to oil supply; 5) the plunger is always tilted downwards under the force from the wrench, resulting in severe unilateral wear and oil leakage.

### SUMMARY

Aiming at the defect that the distance from the force point of the wrench to the rotation axis is limited by the maximum swinging angle of the wrench in a case that the stroke of the plunger reaches its maximum when the wrench of the existing manual hydraulic pipe expander is abutted with the outer surface of the handle, the purpose of the present utility model is to provide a manual hydraulic pipe expander, which can make the force point of the wrench farther away from its rotation axis and more labor-saving on the premise that the maximum swinging angle of the wrench is unchanged. Further, it solves other problems mentioned in the background.

In order to achieve the purpose, the present utility model adopts the following technical solution: a manual hydraulic pipe expander, including:

a handle provided with a gripping part;

a wrench swingable relative to the handle;

a plunger movable back and forth relative to the handle;

an oil bag; and

a pipe expanding assembly including a pipe expanding tube, a piston and a cone head provided in the pipe expanding tube, and a pipe expanding head provided on the pipe expanding tube, the pipe expanding assembly being provided with an oil path respectively communicated with the oil bag, the plunger and the piston,

the handle and the wrench being configured to, in a case that the swinging angle of the wrench is maximum, projections of the wrench and the gripping part of the handle on a swinging plane formed by the wrench coinciding with each other.

Compared with the existing technology in which the wrench can only be abutted with the outer surface of the handle at most, in the manual hydraulic pipe expander provided in the present utility model, in a case that the swinging angle of the wrench is maximum, the projections of the wrench and the gripping part of the handle on the swinging plane formed by the wrench coincide with each, that is, in a case that the swinging angle of the wrench is maximum, the pulling position of the finger on the wrench can be farther away from the rotation axis of the wrench, making it more labor-saving. The effect that the projection of the wrench and the gripping part of the handle on the swinging plane formed by the wrench coincide with each other can be achieved through the misalignment of the wrench and the gripping part of the handle, or by opening an accommodating groove or avoidance groove in the handle. In the process of operating the wrench to rotate it towards the handle, in a case that the wrench cannot continue to move in that direction, the swinging angle of the wrench reaches its maximum. At this time, the stroke of the plunger usually reaches its maximum, and the plunger cannot continue to move towards the piston.

As an improvement, the handle is provided with a wrench groove for accommodating the wrench.

As an improvement, a middle of a thickness direction of the handle is provided with the wrench groove, so that the cross section of the handle is in a concave shape on the whole. In other solutions, the wrench groove may also be provided in the edge of the thickness direction of the handle, so that the cross section of the handle is in an L shape on the whole.

As an improvement, in a case that the swinging angle of the wrench is maximum, the wrench is only partially accommodated in the wrench groove. After practical use, it is found that the wrench can be fully accommodated in the wrench groove. Compared with the case that only a part is accommodated in the wrench groove, although it is more labor-saving, the operating experience is not ideal. Therefore, by designing the manual hydraulic pipe expander so that the wrench is only partially accommodated in the wrench groove, a better operating experience can be provided and it is still more labor-saving than the existing technology.

As an improvement, the handle includes a first handle shell and a second handle shell that are in surface fit with each other, and the first handle shell and the second handle shell are fixedly connected through screws along a thickness direction of the handle.

As an improvement, a positioning structure is formed between the first handle shell and the second handle shell, and the positioning structure includes multiple groups of positioning holes and positioning columns fit with each other.

As an improvement, the manual hydraulic pipe expander further includes a housing, the housing includes a first shell and a second shell, the first shell and the second shell are fixedly connected through screws along the thickness direction of the handle, and a lower end of the housing is clamped with an upper end of the handle along a height direction. Compared with the solution of integrally providing the housing and the handle (that is, there is only one shell), in the present utility model, since the housing and the handle are separately provided, in a case that there is a manufacturing error in the brackets, the first handle shell and the second handle shell of the handle can be displaced relative to the housing within a certain range, which is conducive to the assembling of the brackets and the handle.

As an improvement, a positioning structure is formed between the first shell and the second shell, and the positioning structure includes multiple groups of positioning holes and positioning columns fit with each other.

As an improvement, an angle between the housing and an end surface of the handle close to the wrench is between 95° and 120°.

As an improvement, the oil bag is located between the plunger and the piston, the wrench groove includes a side groove in the side close to the wrench and a top surface groove in a top of the handle, the side groove is communicated with the top groove, a pair of brackets are provided in the handle, upper ends of the brackets are higher than the handle, and the wrench is rotatably connected with the brackets. By providing the oil bag between the plunger and the piston instead of providing it in the handle in the existing technology, the design space of the handle is larger. At the same time, the size of the single-handle operating part of the handle can be smaller, which is conducive to labor saving.

As an improvement, an upper end of the wrench is provided with two parallel parts, and a roller for abutting the plunger is provided between the two parallel parts, and a rotation axis of the roller is higher than a rotation axis of the wrench. By connecting the wrench and the plunger through the roller, the friction can be reduced and the wear can be decreased.

As an improvement, the two parallel parts at the upper end of the wrench are provided with rotatable mounting holes and roller mounting holes, a pin shaft is provided in the rotatable mounting holes, a shaft sleeve that rotates relative to the pin shaft is provided outside the pin shaft, the pin shaft includes a middle that is larger and two ends that are smaller, and the two ends of the pin shaft are provided with locknuts.

As an improvement, a cushion sleeve is further provided between the two parallel parts of the wrench and the brackets; a pin is provided in the roller mounting holes, two ends of the pin are provided with circlips, and the roller is in clearance fit with the pin.

As an improvement, the roller includes a stepped segment in a middle and protruding segments at two ends, and a large-diameter part of the stepped segment is abutted with the plunger.

As an improvement, in a case that the wrench is located at a first limit position away from the handle, the rotation axis of the roller is located on one side of the rotation axis of the wrench, and in a case that the wrench is located at a second limit position close to the handle, the rotation axis of the roller is located on the other side of the rotation axis of the wrench. By adopting such structure, during the movement of the wrench towards the handle, the acting force applied by the roller to the plunger changes from one direction to another, instead of always being in the same direction as in the existing technology, to prevent the seal ring at the plunger from being always subjected to unilateral force.

As an improvement, a cross section of the wrench is in a U shape.

As an improvement, a limiting column for limiting the maximum swinging angle of the wrench is provided between the pair of brackets.

As an improvement, the brackets include parallel segments parallel to the gripping part, and the parallel segments obliquely extend upwards in a direction away from the wrench to form inclined segments. Since inclined segments are formed on the brackets, compared with the case that the brackets are in a linear shape on the whole, the rotation axis of the wrench is farther away from the plunger, making the center of gravity of the manual hydraulic pipe expander farther away from the wrench, achieving a better layout of the manual hydraulic pipe expander.

As an improvement, an upper part of the handle extends towards the side away from the wrench to form a protruding part.

As an improvement, a plunger chamber is formed in the pipe expanding tube, and one end of the plunger is located in the plunger chamber.

As an improvement, the oil bag sleeves the pipe expanding tube.

As an improvement, the oil bag is provided in the handle, the upper end of the wrench is rotatably connected with the handle, and the plunger is located below the rotation axis of the wrench. Such structure requires minor changes based on the existing design. In this case, the arrangement of the oil bag and the wrench can be achieved by means of reducing the oil bag, adjusting the position and structure of the oil bag in the handle, etc.

As an improvement, in a case that the swinging angle of the wrench is maximum, the wrench and the handle are misaligned, and the projections of the wrench and the gripping part of the handle on the swinging plane formed by the wrench coincide with each other.

The manual hydraulic pipe expander provided in the present utility model has the following beneficial effects: a wrench groove is formed in the handle and the wrench can be fully or partially accommodated in the wrench groove, so that in a case that the maximum swinging angle of the wrench is not changed, the pulling position of the finger on the wrench can be farther away from the rotation axis of the wrench, making it more labor-saving; further, since the oil bag is provided between the plunger and the piston, the design space for the handle is larger; at the same time, the size of the single-hand operating part of the handle can be smaller, which is conducive to labor saving; since the rotation axis of the wrench is located above the handle and behind the plunger, the length of the wrench can be larger; since the movement direction of the plunger is the same as that of the piston, the oil path is simple, the manufacturing is facilitated, and the length of the oil path is reduced; since the force on the plunger from the wrench is not always in the same direction, unilateral wear and oil leakage are avoided.

### DESCRIPTION OF THE DRAWINGS

FIG. 1 and FIG. 2 illustrate schematic structural diagrams of a manual hydraulic pipe expander from different angles according to embodiment 1 of the present utility model.

FIG. 3 illustrates a sectional view of a manual hydraulic pipe expander according to embodiment 1 of the present utility model (in a case that a wrench is located at a first limit position away from a handle).

FIG. 4 illustrates a sectional view of a manual hydraulic pipe expander according to embodiment 1 of the present utility model (in a case that a wrench is located at a second limit position close to a handle).

FIG. 5 illustrates an exploded structural diagram of a manual hydraulic pipe expander according to embodiment 1 of the present utility model.

FIG. 6 illustrates a schematic structural diagram of a manual hydraulic pipe expander after partial components are concealed according to embodiment 1 of the present utility model.

FIG. 7 illustrates an exploded structural diagram of a handle of a manual hydraulic pipe expander according to embodiment 1 of the present utility model.

FIG. 8 illustrates a schematic structural diagram of a part of a manual hydraulic pipe expander according to embodiment 1 of the present utility model.

FIG. 9 illustrates an exploded structural diagram of a part of a manual hydraulic pipe expander according to embodiment 1 of the present utility model.

FIG. 10 illustrates a schematic structural diagram of a wrench of a manual hydraulic pipe expander according to embodiment 1 of the present utility model.

Description of reference signs: 1—handle; 1A—first handle shell; 1B—second handle shell; 11—gripping part; 12—protruding part; 13—wrench groove; 14—positioning hole; 15—positioning column;
2—wrench; 21—parallel part; 22—rotatable mounting hole; 23—roller mounting hole; 24—middle segment; 25—finger force part;
3—plunger;
4—pipe expanding assembly; 41—pipe expanding tube; 42—piston; 43—cone head;
5—oil bag;
6—bracket;
7—roller;
8—housing;
9—limiting column

### DESCRIPTION OF THE EMBODIMENTS

The technical solutions of the embodiments of the present utility model will be explained and described below. However, the following embodiments are only preferred embodiments of the present utility model and not all of the embodiments. Based on the embodiments of the present utility model, other embodiments obtained by those skilled in the art without contributing any inventive labor still fall within the scope of protection of the present utility model.

### Embodiment 1

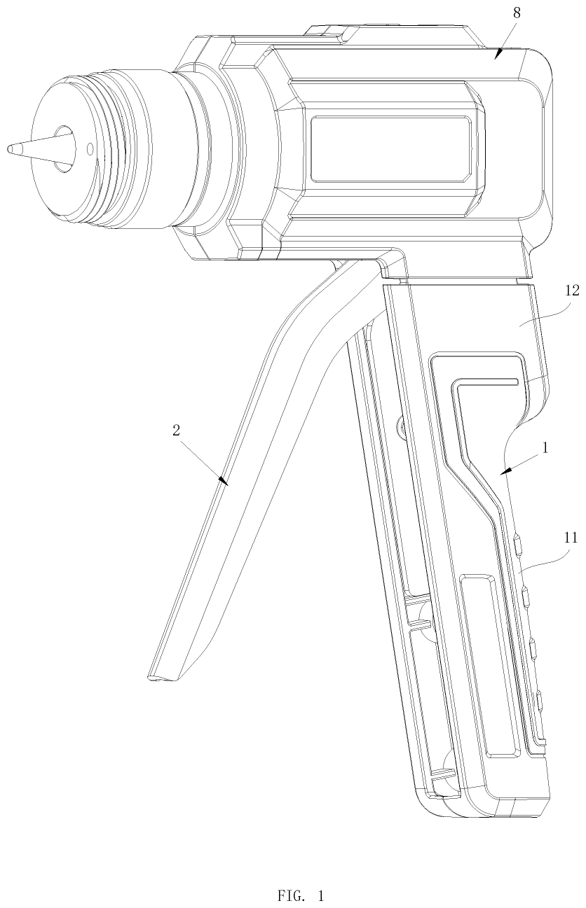

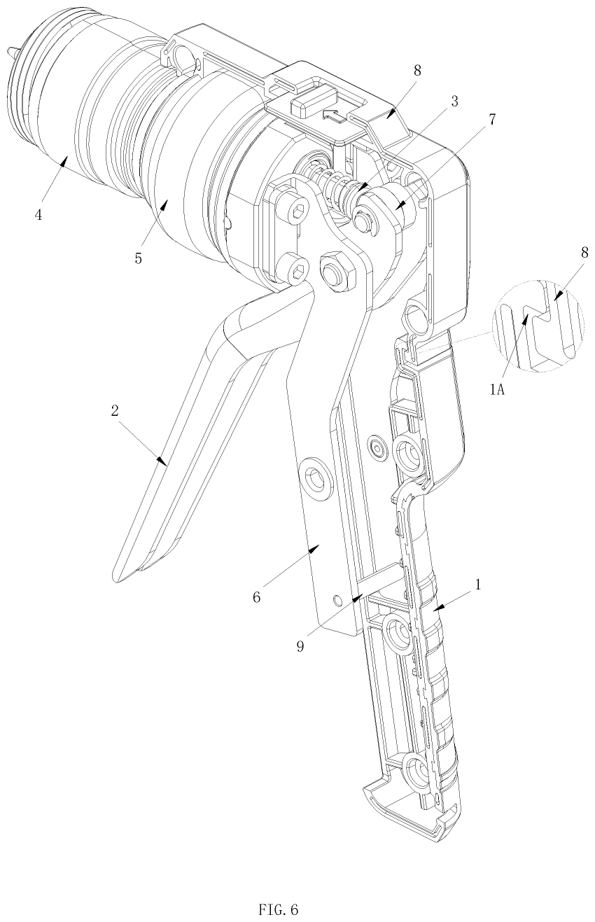

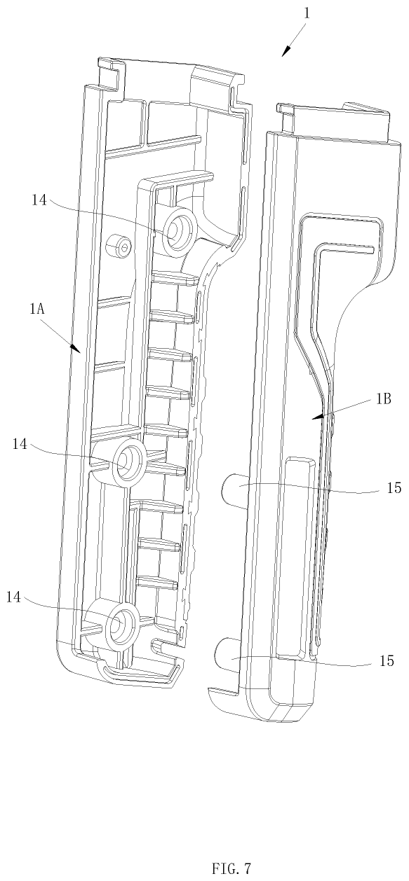

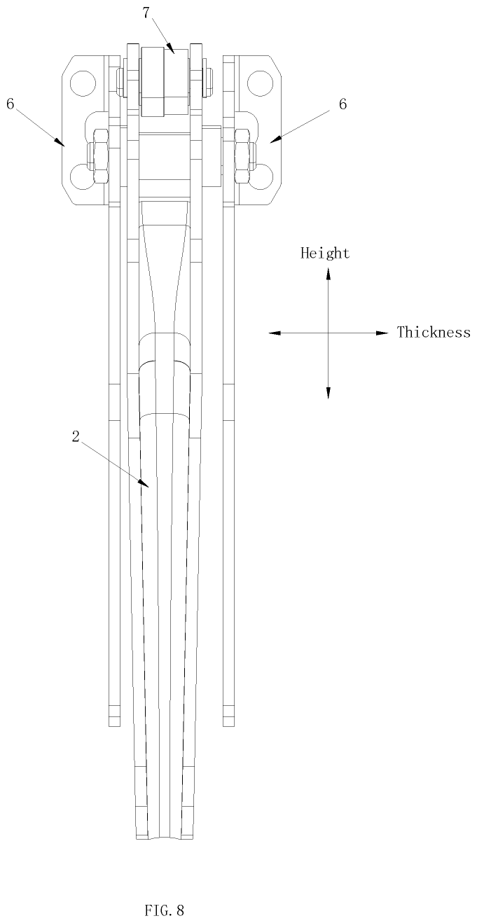

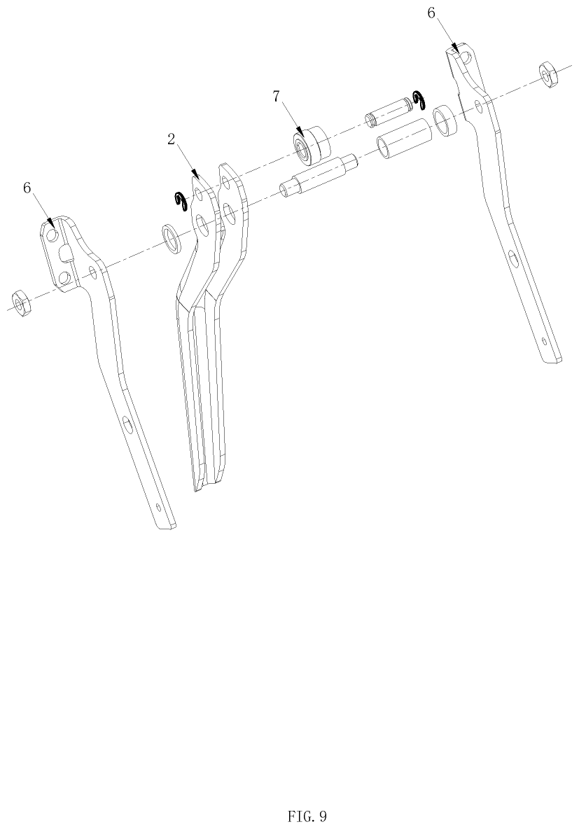

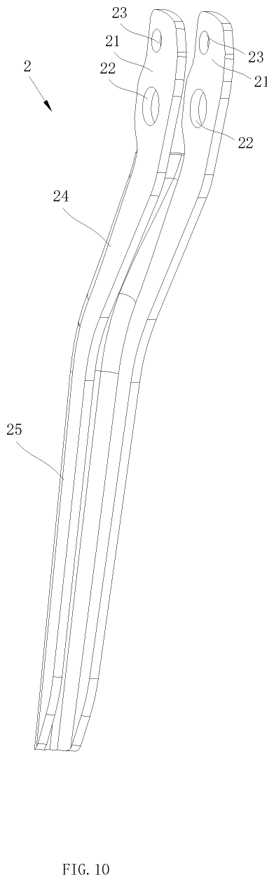

Referring to FIG. 1 to FIG. 10, embodiment 1 of the present utility model provides a manual hydraulic pipe expander. The manual hydraulic pipe expander includes:

a handle 1 provided with a gripping part 11;

a wrench 2 swingable relative to the handle 1;

a plunger 3 movable back and forth relative to the handle 1;

an oil bag 5; and

a pipe expanding assembly 4 including a pipe expanding tube 41, a piston 42 and a cone head 43 provided in the pipe expanding tube 41, and a pipe expanding head provided on the pipe expanding tube 41, the pipe expanding assembly 4 being provided with an oil path respectively communicated with the oil bag 5, the plunger 3 and the piston 42,

the handle 1 and the wrench 2 being configured to, in a case that the swinging angle of the wrench 1 is maximum, projections of the wrench 2 and the gripping part 11 of the handle 1 on a swinging plane formed by the wrench 2 coinciding with each other.

In the figures, the pipe expanding head is not illustrated.

In this embodiment, the handle 1 is provided with a wrench groove 13 for accommodating the wrench 2.

In other embodiments, the wrench groove may also be provided in the edge of the thickness direction of the handle, so that the cross section of the handle is in an L shape on the whole.

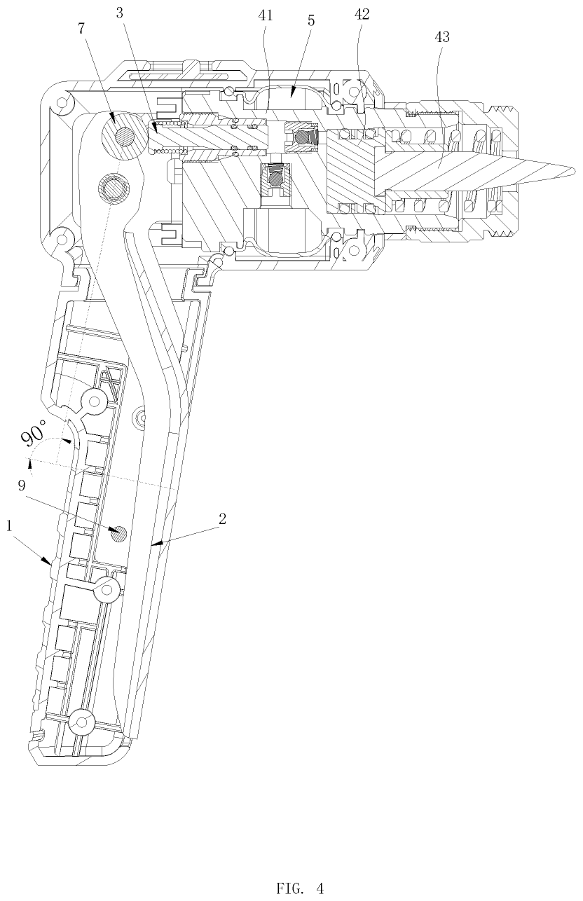

In this embodiment, referring to FIG. 4, in a case that the swinging angle of the wrench 2 reaches its maximum, a small part of the wrench 2 is still outside the wrench groove 13, so that the wrench 2 is not completely accommodated in the wrench groove 13, allowing the user to obtain better operation experience.

In this embodiment, the handle 1 includes a first handle shell 1A and a second handle shell 1B that are in surface fit with each other, and the first handle shell 1A and the second handle shell 1B are fixedly connected through screws along a thickness direction of the handle 1.

In this embodiment, the number of fitting surface of the first handle shell 1A and the second handle shell 1B is one.

In this embodiment, a positioning structure is formed between the first handle shell 1A and the second handle shell 1B, and the positioning structure includes multiple groups of positioning holes 14 and positioning columns 15 fit with each other. When assembling the handle 1, the positioning columns 15 are aligned with the positioning holes 14, and the screws are mounted. The positioning holes 14 are countersunk holes. The positioning structure further includes positioning strips and positioning grooves formed on the edges and fit with each other. Reinforcing ribs are provided in the first handle shell 1A and/or the second handle shell 1B.

In this embodiment, a flexible member may also be integrally formed on each of the first handle shell 1A and the second handle shell 1B of the handle 1. The flexible member is located at the gripping part 11, so as to improve the hand feeling of the user. The first handle shell 1A and the second handle shell 1B are usually made of hard plastic.

In this embodiment, the oil bag 5 is located between the plunger 3 and the piston 42. By providing the oil bag 5 between the plunger 3 and the piston 42 instead of providing it in the handle 1 in the existing technology, the design space of the handle ‘1 is larger. At the same time, the size of the single-handle operating part of the handle 1 can be smaller, which is conducive to labor saving.

In this embodiment, the wrench groove 13 includes a side groove in the side close to the wrench 2 and a top surface groove in a top of the handle 1, the side groove is communicated with the top groove, a pair of brackets 6 are provided in the handle 1, upper ends of the brackets 6 are higher than the handle 1, and the wrench 2 is rotatably connected with the brackets 6.

In this embodiment, an upper end of the wrench 2 is provided with two parallel parts 21, and a roller 7 for abutting the plunger 3 is provided between the two parallel parts 21, and a rotation axis of the roller 7 is higher than a rotation axis of the wrench 2. By connecting the wrench 2 and the plunger 3 through the roller 7, the friction can be reduced and the wear can be decreased.

In this embodiment, the two parallel parts 21 at the upper end of the wrench 2 are provided with rotatable mounting holes 22 and roller mounting holes 23, a pin shaft is provided in the rotatable mounting holes 22, a shaft sleeve that rotates relative to the pin shaft is provided outside the pin shaft, the pin shaft includes a middle that is larger and two ends that are small, and the two ends of the pin shaft are provided with locknuts. A cushion sleeve is further provided between the two parallel parts 21 of the wrench 2 and the brackets 6. By adopting such structure to mount the wrench 2, the wrench 2 will not shake along the thickness direction of the handle 1, and the arrangement of the shaft sleeve can reduce the friction and improve the service life.

In this embodiment, a pin is provided in the roller mounting holes 23, two ends of the pin are provided with circlips, and the roller 7 is in clearance fit with the pin.

In this embodiment, the thickness of the wrench 2 is uniform, the cross section of the wrench 2 is in a U shape. The wrench 2 may be made of a metal material.

In this embodiment, a limiting column 9 for limiting the maximum swinging angle of the wrench 2 is provided between the pair of brackets 6. The limiting column 9 includes a middle that is larger and two ends that are smaller, and the two ends of the limiting column 9 are inserted into the two brackets 6.

In this embodiment, a plunger 3 chamber is formed in the pipe expanding tube 41, and one end of the plunger 3 is located in the plunger 3 chamber

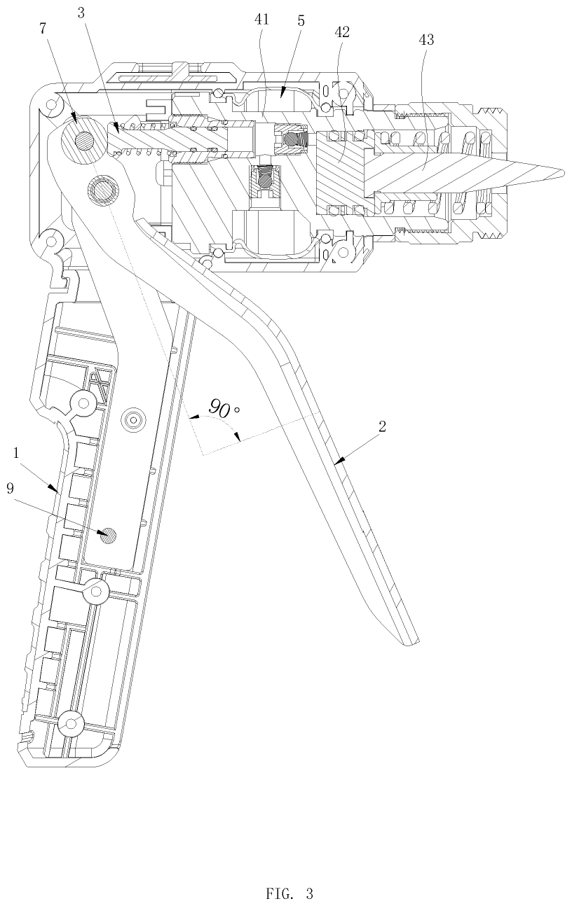

In this embodiment, referring to FIG. 3 and FIG. 4, in a case that the wrench 2 is located at a first limit position away from the handle 1, the rotation axis of the roller 7 is located on one side of the rotation axis of the wrench 2, and in a case that the wrench 2 is located at a second limit position close to the handle 1, the rotation axis of the roller 7 is located on the other side of the rotation axis of the wrench 2. By adopting such structure, during the movement of the wrench 2 towards the handle 1, the acting force applied by the roller 7 to the plunger 3 changes from one direction to another, instead of always being in the same direction as in the existing technology, thus preventing the seal ring at the plunger 3 from being always subjected to unilateral force.

In this embodiment, the gripping part 11 is located at a lower part of the handle 1, an upper part of the handle 1 extends towards the side away from the wrench 2 to form a protruding part 12, the brackets 6 include parallel segments parallel to the gripping part 11, and the parallel segments obliquely extend upwards in a direction away from the wrench 2 to form inclined segments. Since inclined segments are formed on the brackets 6, compared with the case that the brackets 6 are in a linear shape on the whole, the rotation axis of the wrench 2 is farther away from the plunger 3, making the center of gravity of the manual hydraulic pipe expander farther away from the wrench 2, achieving a better layout of the manual hydraulic pipe expander.

In this embodiment, the oil bag 5 sleeves the pipe expanding tube 41. An oil storage space is formed between an outer wall of the pipe expanding tube 41 and an inner wall of the oil bag 5. An oil supply path and an oil return path are formed in the pipe expanding tube 41.

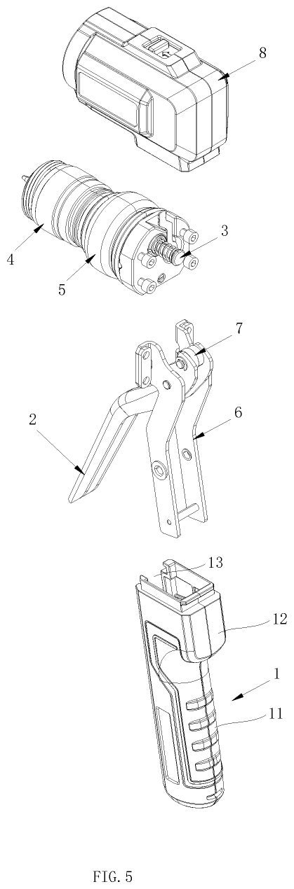

In this embodiment, referring to FIG. 5, the manual hydraulic pipe expander further includes a housing 8, the housing 8 includes a first shell and a second shell, the first shell and the second shell are fixedly connected through screws along the thickness direction of the handle 1, and a lower end of the housing 8 is clamped with an upper end of the handle 1 along a height direction. Different from the existing technology in which the housing 8 and the handle 1 may be integrally provided, separately providing the housing 8 and the handle 1 is conductive to the assembling of the brackets 6 and the handle 1.

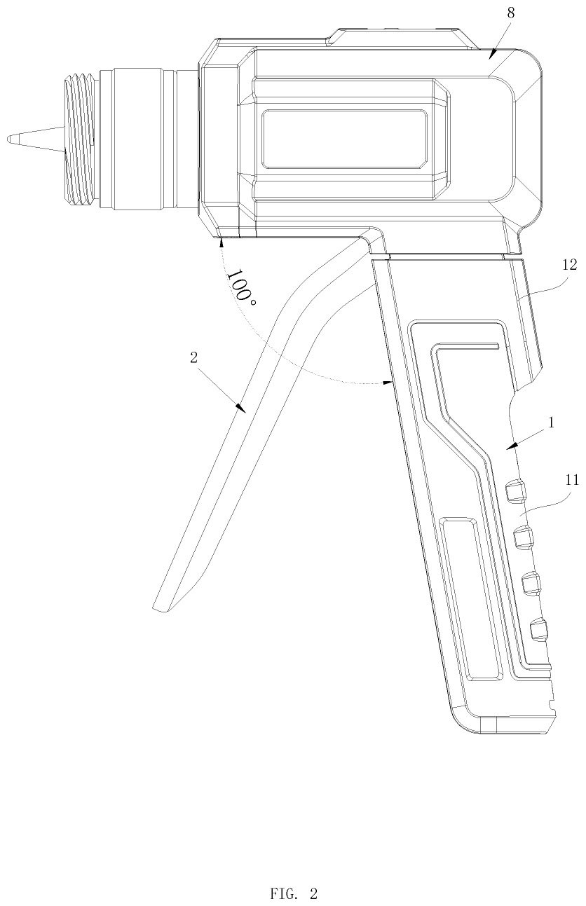

In this embodiment, referring to FIG. 2, an angle between the housing 8 and the handle 1 is between 95° and 120°. Specifically, in this embodiment, the angle is 100°.

In this embodiment, referring to FIG. 3 and FIG. 4, the wrench 2 includes a rotatable connecting part, a middle part 24 and a finger force part 25, and the finger force part 25 of the wrench 2 is parallel to a plane formed by the rotation axis of the wrench 2 and the rotation axis of the roller 7.

For other structures not described in this embodiment, a reference may be made to the drawings and the existing technology.

The working principle of the manual hydraulic pipe expander in this embodiment is as follows: referring to FIG. 3, when no external force is applied, under the action of the compression spring at the plunger 3, the opening angle of the wrench 2 is maximum; at this time, the cone head 43 and the piston 42 are closest to the handle 1, that is, the extension length is the smallest, under the action of the compression spring at the cone head 43; referring to FIG. 4, the handle 1 is gripped with a single hand and force is applied to the wrench 2 with the finger, causing the wrench 2 to swing towards the handle 1; due to the presence of the wrench groove 13 in the handle 1, till the wrench 2 is abutted with the limiting column 9 in the handle 1, the rotation angle of the wrench 2 reaches its maximum, and the stroke of the plunger 3 also reaches its maximum; by providing the wrench groove 13, compared with the case that no wrench groove 13 is provided, in a case that the maximum swinging angle of the wrench 2 is the same, that is, the maximum stroke of the plunger 3 is the same, when there is no external force, the angle between the wrench 2 and the handle 1 is smaller, so that the finger can apply force at a position on the wrench 2 farther away from the rotation axis of the wrench 2, making it more labor-saving; after the finger is released, the wrench 2 and the plunger 3 are restored under the action of the compression spring at the plunger 3; the wrench 2 is repeatedly operated for many times in such a way; when the compression amount is enough, the oil pressure at the piston 42 reaches relief pressure, the relief valve automatically relieves the pressure to complete pipe expansion; after pressure relief, the piston 42 and the cone head 43 are restored under the action of the compression spring at the cone head 43; in a case that the pressure needs to be relieved before the relief pressure is reached or the relief valve is faulted, the relief member on the housing 8 can be manually operated to achieve pressure relief.

The manual hydraulic pipe expander provided in embodiment 1 of the present utility model has the following beneficial effects: a wrench groove 13 is formed in the handle 1 and the wrench 2 can be fully or partially accommodated in the wrench groove 13, so that in a case that the maximum swinging angle of the wrench 2 is not changed, the pulling position of the finger on the wrench 2 can be farther away from the rotation axis of the wrench 1, making it more labor-saving; since the oil bag 5 is provided between the plunger 3 and the piston 42, the design space for the handle 1 is larger; at the same time, the size of the single-hand operating part of the handle 1 can be smaller, which is conducive to labor saving; since the rotation axis of the wrench 2 is located above the handle 1 and behind the plunger 3, the length of the wrench 2 can be larger; since the movement direction of the plunger 3 is the same as that of the piston 42, the oil path is simple, the manufacturing is facilitated, and the length of the oil path is reduced; since the force on the plunger 3 from the wrench 2 is not always in the same direction, unilateral wear is avoided, the service life of the seal ring at the plunger 3 is longer, and oil leakage is avoided.

### Embodiment 2

In this embodiment, the oil bag is provided in the handle, the upper end of the wrench is rotatably connected with the handle, and the plunger is located below the rotation axis of the wrench. Such structure requires minor changes based on the US patent solution. In this case, the arrangement of the oil bag and the wrench can be achieved by means of reducing the oil bag, adjusting the position and structure of the oil bag in the handle, etc.

### Embodiment 3

In this embodiment, in a case that the swinging angle of the wrench is maximum, the wrench and the handle are misaligned, and the projections of the wrench and the gripping part of the handle on the swinging plane formed by the wrench coincide with each other.

What are described above are only specific embodiments of the present utility model, but the scope of protection of the present utility model is not limited thereto. Those skilled in the art should understand that the present utility model includes but not limited to the content described in the specific embodiments above. Any modifications that do not deviate from the functional and structural principles of the present utility model are included within the scope of the claims.

1. A manual hydraulic pipe expander, comprising:
a handle provided with a gripping part;
a wrench swingable relative to the handle;
a plunger movable back and forth relative to the handle;
an oil bag; and
a pipe expanding assembly comprising a pipe expanding tube, a piston and a cone head provided in the pipe expanding tube, and a pipe expanding head provided on the pipe expanding tube, the pipe expanding assembly being provided with an oil path respectively communicated with the oil bag, the plunger and the piston,
the handle and the wrench being configured to, in a case that the swinging angle of the wrench is maximum, projections of the wrench and the gripping part of the handle on a swinging plane formed by the wrench coinciding with each other.

2. The manual hydraulic pipe expander according to claim 1, wherein the handle is provided with a wrench groove for accommodating the wrench.

3. The manual hydraulic pipe expander according to claim 2, wherein a middle of a thickness direction of the handle is provided with the wrench groove; in a case that the swinging angle of the wrench is maximum, the wrench is only partially accommodated in the wrench groove.

4. The manual hydraulic pipe expander according to claim 2, wherein the handle comprises a first handle shell and a second handle shell that are in surface fit with each other, the first handle shell and the second handle shell are fixedly connected through screws along a thickness direction of the handle, and a positioning structure is formed between the first handle shell and the second handle shell;
the manual hydraulic pipe expander further comprises a housing, the housing comprises a first shell and a second shell, the first shell and the second shell are fixedly connected through screws along the thickness direction of the handle, and a lower end of the housing is clamped with an upper end of the handle along a height direction;
an angle between the housing and an end surface of the handle close to the wrench is between 95° and 120°.

5. The manual hydraulic pipe expander according to claim 2, wherein the oil bag is located between the plunger and the piston, the wrench groove comprises a side groove in the side close to the wrench and a top surface groove in a top of the handle, the side groove is communicated with the top groove, a pair of brackets are provided in the handle, upper ends of the brackets are higher than the handle, and the wrench is rotatably connected with the brackets;
an upper end of the wrench is provided with two parallel parts, and a roller for abutting the plunger is provided between the two parallel parts, and a rotation axis of the roller is higher than a rotation axis of the wrench.

6. The manual hydraulic pipe expander according to claim 5, wherein the two parallel parts at the upper end of the wrench are provided with rotatable mounting holes and roller mounting holes, a pin shaft is provided in the rotatable mounting holes, a shaft sleeve that rotates relative to the pin shaft is provided outside the pin shaft, the pin shaft comprises a middle that is larger and two ends that are smaller, and the two ends of the pin shaft are provided with locknuts; a cushion sleeve is further provided between the two parallel parts of the wrench and the brackets; a pin is provided in the roller mounting holes, two ends of the pin are provided with circlips, and the roller is in clearance fit with the pin;
the roller comprises a stepped segment in a middle and protruding segments at two ends, and a large-diameter part of the stepped segment is abutted with the plunger.

7. The manual hydraulic pipe expander according to claim 5, wherein in a case that the wrench is located at a first limit position away from the handle, the rotation axis of the roller is located on one side of the rotation axis of the wrench, and in a case that the wrench is located at a second limit position close to the handle, the rotation axis of the roller is located on the other side of the rotation axis of the wrench;
a cross section of the wrench is in a U shape;
the wrench further comprises a middle part and a finger force part, the finger force part of the wrench is parallel to a plane formed by the rotation axis of the wrench and the rotation axis of the roller;
a limiting column for limiting the maximum swinging angle of the wrench is provided between the pair of brackets; the brackets comprise parallel segments parallel to the gripping part, and the parallel segments obliquely extend upwards in a direction away from the wrench to form inclined segments.

8. The manual hydraulic pipe expander according to claim 4, wherein an upper part of the handle extends towards the side away from the wrench to form a protruding part;
the oil bag sleeves the pipe expanding tube;
a plunger chamber is formed in the pipe expanding tube, and one end of the plunger is located in the plunger chamber.

9. The manual hydraulic pipe expander according to claim 2, wherein the oil bag is provided in the handle, the upper end of the wrench is rotatably connected with the handle, and the plunger is located below the rotation axis of the wrench.

10. The manual hydraulic pipe expander according to claim 1, wherein in a case that the swinging angle of the wrench is maximum, the wrench and the handle are misaligned, and the projections of the wrench and the gripping part of the handle on the swinging plane formed by the wrench coincide with each other.
